(19) United States
(12) Patent Application Publication
(10) Pub. No.: US 2005/0090348 A1
(43) Pub. Date: Apr. 28, 2005

(54) Roller chain

(75) Inventor: Takashi Tohara, Osaka (JP)

Correspondence Address: KENNETH L. MITCHELL;(WOODLING, KROST AND RUST), 9213 CHILLICOTHE ROAD, KIRTLAND, OH, 44094, US

(73) Assignee: Tsubakimoto Chain Co. (Japanese Corporation)

(21) Appl. No.: 10/915,060

(22) Filed: Aug. 9, 2004

(30) Foreign Application Priority Data
Oct. 28, 2003 (JP) 2003-367524

(51) Int. Cl. F16H 7/06; F16G 13/04

(52) U.S. Cl. 474/155

(57) ABSTRACT

To provide a roller chain, which does not generate abnormal wear elongation and smoothly articulately slide for a long period of time even if the roller chain is used together with an extremely deteriorated lubricating oil having a high degree of oxidation. In a roller chain in which both ends of a bush are press-fit to bush holes of a pair of inner plates, both ends of a pin loosely penetrated into the bush are press-fit into pin holes of a pair of outer plates disposed outside the both pair of inner plates and a roller is fit onto said bush, a material of said bush is carburized stainless steel and a vanadium carbide layer is formed on the surface of the pin.

This patent application claims priority to Japanese Patent Application No. 2003-367524 filed Oct. 28, 2003.

### TECHNICAL FIELD

The present invention relates to a roller chain used for a camshaft transmission mechanism for an automobile engine, a power transmission mechanism or a conveyor mechanism in industrial machines or the like.

### BACKGROUND ART

As a power transmission medium used in a camshaft transmission mechanism in an automobile engine a metallic roller chain excellent in endurance has been increasingly used from demands for high load, high speed and maintenance free in place of a toothed belt, which has been well used.

The conventional metallic roller chain usually has a configuration that both ends of a cylindrical bush are press-fit into bush holes of a pair of inner plates, both ends of a pin loosely penetrated into said bush are press-fit into a pair of outer plates disposed outside both said pair of inner plates and a roller is fit onto said bush.

In the thus formed conventional metallic roller chain, to obtain improvements of strength and wear elongation, pins have been subjected to heat treatment such as hardening/tempering, carburization/nitriding or the like, a chromium carbide layer has been formed on the surface of a pin, and a bush formed of an alloy steel such as a sintered alloy or the like has been subjected to carburization and nitriding (see for example, Patent Document 1).

Patent Document 1: Japanese Laid-open Utility Model Publication No. Hei. 1-149048.

### PROBLEMS TO BE SOLVED BY THE INVENTION

However, it has been reported that in spite of the heat treatment for the pins and bushes and the formation of a chromium carbide layer on the pin surface, when the above-mentioned roller chain is used as a timing chain in an automobile engine, extremely few chains, which do not exert expected wear resistance and generate abnormally bad wear elongation, exist.

In the automobile engine the elongation of the chain can be absorbed by a tensioner. However, when the elongation exceeds its limit, noise is generated and jumping the sprocket teeth is also generated, which can lose the quietness and endurance of the engine. Therefore, it was an urgent matter to remove the abnormal wear elongation to further improve performance and reliability of an engine.

Therefore, the present inventors continued study very positively to solve the above-mentioned problems. As a result, they have found that when an automobile subjected to suitable maintenance such as a periodical exchange of a lubricating oil is run in usual running conditions, the above-described abnormal wear elongation of the roller chain is not generated, but when the lubricating oil exchange and the like are not taken whereby the lubricating oil in the engine room remarkably deteriorates and the oxidation of the lubricating oil advances to pH<4.5, the above-described abnormal wear elongation of the roller chain is generated. The mechanism is guessed to be the facts that a surface of the bush is corroded by a lubricating oil having high degree of oxidation and the sliding contact between the bush and the pin under high load promotes wear of sliding contact surfaces.

Further, it has also become clear that since wear powder generated by the wear exists between a pin and a bush as an inclusion, wear is further promoted, that is abrasion is a reason of abnormal wear of the sliding contact surface between the pin and the bush. Further, it has also become clear that when the pin and the bush are made of materials having high affinity, for example the same elements, the both materials are apt to adhere to each other and the adherence becomes a reason for preventing smooth bending slide of the roller chain.

Accordingly, the object of the present invention is to solve the problems of a conventional roller chain and to provide a roller chain, which smoothly bending slides for a long period of time without generating abnormal wear elongation even if the roller chain is used together with an extremely deteriorated lubricating oil having a high degree of oxidation.

### MEANS FOR SOLVING THE PROBLEMS

The roller chain according to claim 1 solves the above-mentioned problems by a roller chain in which both ends of a bush are press-fit to bush holes of a pair of inner plates, both ends of a pin loosely penetrated into said bush are press-fit into pin holes of a pair of outer plates disposed outside said both pair of inner plates and a roller is fit onto said bush, characterized in that a material of said bush is carburized stainless steel and a vanadium carbide layer is formed on the surface of said pin.

The roller chain according to claim 2 further solves above-mentioned problems by, in addition to the configuration of the roller chain according to claim 1, that said stainless steel is martensite stainless steel, which can be heat-treated.

### EFFECTS OF THE INVENTION

In the roller chain according to claim 1, since a material of the bush is carburized stainless steel and a vanadium carbide layer is formed on the surface of a pin, a stable protective passivation film is formed on the surface of a bush by the protective passivation action of carburized stainless steel used as a material of the bush. In even a case where the roller was used in an extremely deteriorated lubrication oil having a high degree of oxidation, it is hard for the roller chain to receive the influences of oxidation and corrosion. Further by the covering action of a vanadium carbide layer formed on the surface of a pin, wear due to adherence between the bush and the pin is suppressed. The multiplier effect of these actions improves acid resistance and corrosion resistance in oxidation atmosphere.

Further, in the roller chain according to claim 2, since martensite stainless steel is used as said stainless steel hardening becomes possible and high strengthening of the bush can be obtained in addition to the effect that the roller chain according to claim 1 exerts.

By these effects a roller chain excellent in quietness, endurance and reliability, which smoothly bending slides for a long period of time is provided. Further, extension of service life of a lubricating oil used together with the roller chain is also obtained and reduction in environmental load is also contributed.

### BRIEF DESCRIPTION OF THE DRAWINGS

FIG. 1 is a perspective view showing a portion of a roller chain of the present invention.

FIG. 2 is a graph showing test results of chain elongation in oxidized deteriorated lubricating oil according to the roller chain of the present invention.

FIG. 3 is a graph showing test results of chain elongation in new lubricating oil according to the roller chain of the present invention

FIG. 4 is a graph showing test results of chain elongation in soot-containing oil according to the roller chain of the present invention.

A better understanding of the drawings will be had when reference is made to the DESCRIPTION OF THE INVENTION AND CLAIMS which follow hereinbelow.

### DESCRIPTION OF THE INVENTION

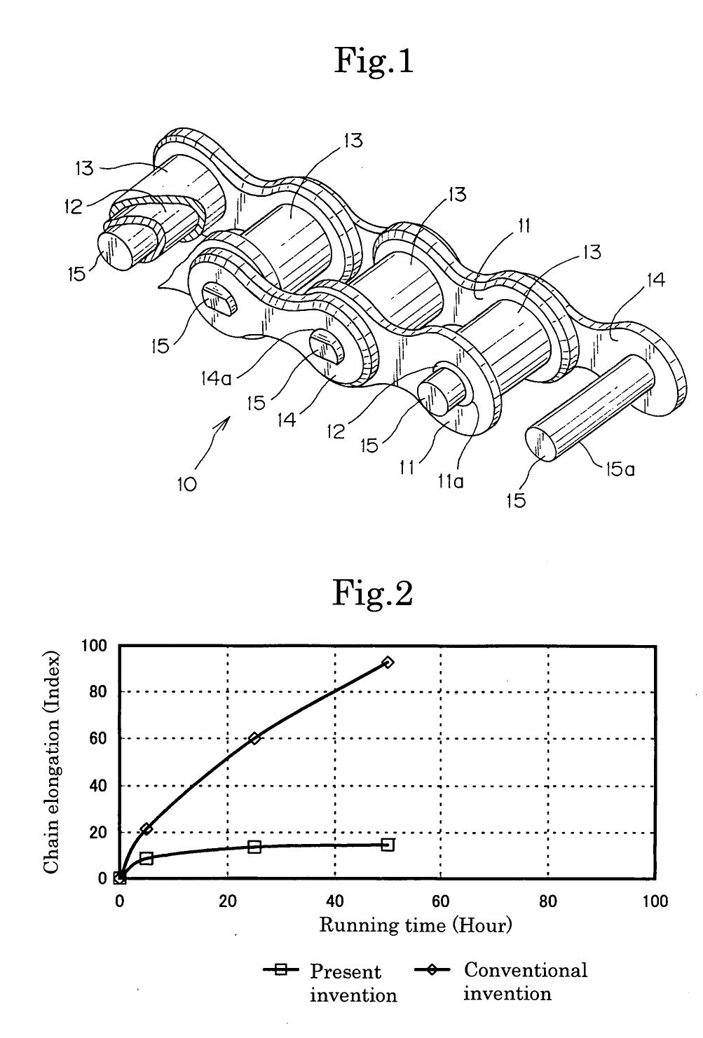

An embodiment of the present invention will be described based on an example with reference to FIG. 1.

FIG. 1 is a perspective view showing a part of a roller chain, which is one example of the present invention. FIG. 1 shows the inside structure of a chain with a cut out part of the chain.

In a roller chain 10, both ends of a bush 12 are press-fit into bush holes 11a of a pair of inner plates 11, both ends of a pin 15 loosely penetrated into said bush 12 are press-fit into pin holes 14a of a pair of outer plates 14 disposed outside said both pair of inner plates 11. And the roller 13 is rotatably fit onto said bush 12.

In the roller chain 10 of the present invention the bush 12 is composed of carburized stainless steel and a vanadium carbide layer having a thickness of 6 to 20 μm is formed on the surface 15a of the pin 15. This vanadium carbide layer is formed by the following method.

First, a pin containing 0.1 to 0.4 weight % carbon, and containing at least one of additional ingredients such as manganese, silicon, chromium, molybdenum and the like, and the rest of iron and impurities, is subjected to carburization so that on the surface of the pin is formed a high carbon surface layer of which amount of carbon is 0.7 to 1.0 weight %. Then a vanadium carbide layer is formed on the surface of the pin by the “powder penetration method” in which the surrounding of the pin is filled with vanadium powder or vanadium alloy powder and heat-treated at high temperature of 900 to 1100° C. for 5 to 25 hours.

In the above-described example, a vanadium carbide layer is formed on the surface of a pin by the “powder penetration method” from the viewpoints of production cost and the like. However, other methods, which can reliably form vanadium carbide, such as “a molten penetration method”, which treats in molten salt, “a chemical vapor deposition method”, which forms a vanadium carbide layer on the surface of a pin by vapor phase chemical reaction, or “a physical vapor deposition method”, which forms a vanadium carbide layer on the surface of a pin by vaporizing vanadium with a physical process such as high temperature heating, sputtering, arc discharge or the like, may also be used. Thus the methods for forming the vanadium carbide layer are not limited.

Further, in the above-described example, the stainless steel used for the bush 12 is martensite stainless steel. Thus hardening is possible and making the strength of the bush high is performed. This martensite stainless steel can be obtained by heating stainless steel at a temperature of the transformation point of Acm or more and maintaining the temperature to obtain a uniform austenite structure and then by quenching the steel in oil (or water). In this case the transformation point of Acm is a transformation, which exists in hypereutectoid steel only. The transformation pint is increased as the amount of carbon is increased. Specifically, when the carbon content is 0.85%, the transformation point is 726° C., and when it is 2.1%, the transformation point is 1145° C.

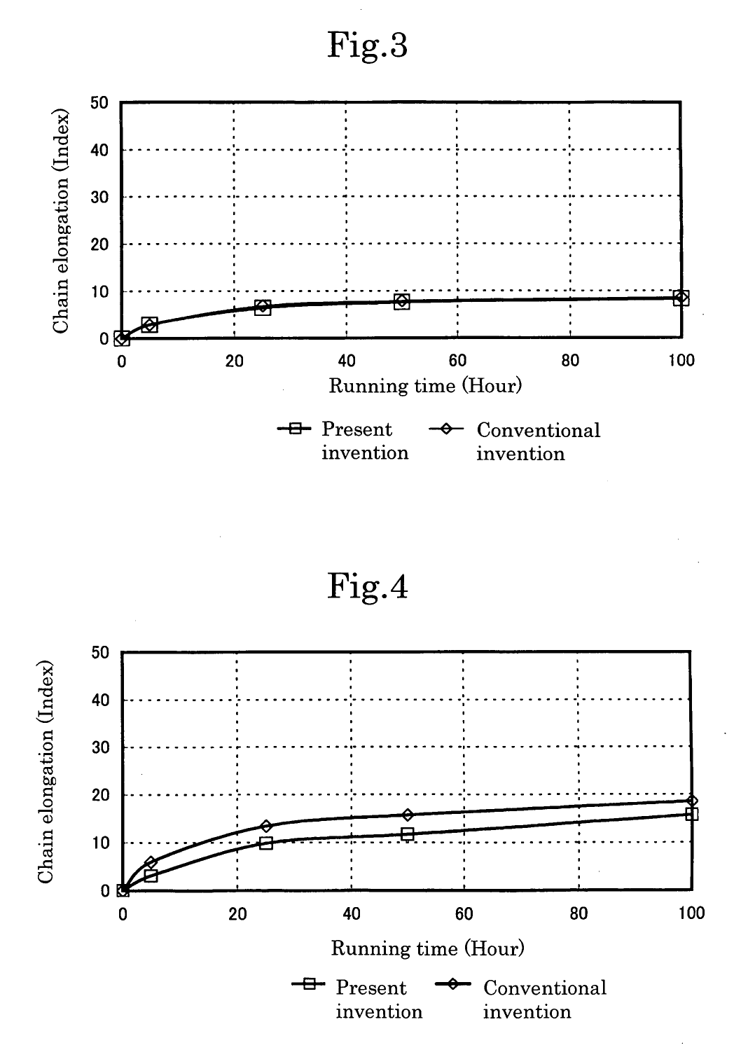

FIGS. 2 to 4 show the test results of chain elongation, which were performed to evaluate wear resistance of the roller chain in the above-mentioned example together with the results of conventional examples. Particularly, FIG. 2 shows test results in an oxidized deteriorated lubricating oil, FIG. 3 shows test results in a new lubricating oil, and FIG. 4 shows test results in a lubricating oil containing soot, that is soot having carbon, which causes abrasion, as the principal component. It is noted that as the conventional product a roller chain in which a bush of a conventional alloy steel carburized and a chromium carbide layer-formed pin are incorporated with each other, is used.

As shown in FIG. 3, the roller chain of the present invention has improvement of elongation properties of about 2 to 3% in new lubricating oil in comparison with the conventional product. This effect is not so high.

However, as shown in FIG. 2, it has been recognized that the elongation ratio in the roller chain of the present invention is further reduced by 80% or more after 50 hours in oxidized deteriorated lubricating oil as compared with the conventional product. Further, as shown in FIG. 4, it has been recognized that the elongation ratio in the roller chain of the present invention is further reduced by about 20% in soot-containing lubricating oil as compared with the conventional product.

These results concluded that since the stainless steel of the bush material is more excellent in corrosion resistance in an oxidizing atmosphere as compared with the alloy steel of a conventional bush material, the roller chain of the present invention is significantly improved in wear resistance properties in the oxidized deteriorated lubricating oil. Further, since the vanadium carbide layer formed pin of the present invention is harder than the only carburized pin and the chromium carbide layer formed pin in the conventional case, wear resistance properties of the roller chain of the present invention are improved in soot-containing oil.

The surface treatment by the formation of a vanadium carbide layer was not recognized to be significantly advantageous surface treatment as compared with other surface treatment such as carburization heat treatment, the formation of chromium carbide layer or the like. However as shown by the above-described experimental results, the vanadium carbide was proved to be very excellent material as a coating material of a pin in a roller chain used under sever conditions such as in oxidized deteriorated lubricating oil or in soot-containing lubricating oil.

Further, it has been recognized that the stainless steel is advantageous to acid. However, the stainless steel is unsuitable for a bush material in a roller chain used in a field of a high load and high rotation from the viewpoints of hardness and the like. Nevertheless these problems are solved by subjecting the bush to carburization treatment. And it has been confirmed that the stainless steel has very excellent properties as a bush material of the roller chain used in an oxidizing atmosphere and a sever environment of high load and high rotation.

Particularly, in a case where stainless steel is used as a bush material, the adherence between the pin and the bush is suppressed by the vanadium carbide layer formed on the surface of the pin. Thus an improvement in wear resistance and endurance of the chain is obtained by an action of a protective passivation layer formed on the surface of stainless steel.

### INDUSTRIAL APPLICABILITY

According to the present invention it has been found that the abnormal wear elongation of the chain was due to the oxidation and deterioration of lubricating oil. From the viewpoint of a mechanism of the abnormal wear elongation, the optimization of the material of a bush and the coating material for the surface of a pin material is performed. Therefore, the present invention has a very large technical meaning in industry since the generation of abnormal wear elongation can be reproducibly avoided without using special production facilities and expensive materials.

### DESCRIPTION OF REFERENCE NUMERALS

10 Roller chain
11 Inner plate
11a Bush hole
12 Bush
13 Roller
14 Outer plate
14a Pin hole
15 Pin
15a Surface of pin

The invention has been set forth by way of examples and those skilled in the art will readily recognize that changes may be made to the invention without departing from the spirit and scope of the appended claims.

1. A roller chain in which both ends of a bush are press-fit to bush holes of a pair of inner plates, both ends of a pin loosely penetrated into said bush are press-fit into pin holes of a pair of outer plates disposed outside said both pair of inner plates and a roller is fit onto said bush, characterized in that
a material of said bush is carburized stainless steel and
a vanadium carbide layer is formed on the surface of said pin.

2. The roller chain according to claim 1, characterized in that said stainless steel is martensite stainless steel.
